(19) United States
(12) Patent Application Publication
(10) Pub. No.: US 2010/0148100 A1
(43) Pub. Date: Jun. 17, 2010

(54) MEDIA ISOLATED PIEZO VALVE

(75) Inventors: JAMES A. BURNS, Wilton, NH (US); Joel Verrecchia, Westford, MA (US); Mark Michaud, Manchester, NH (US)

Correspondence Address: PARKER-HANNIFIN CORPORATION;HUNTER MOLNAR BAKER MORGAN, 6035 PARKLAND BOULEVARD, CLEVELAND, OH, 44124-4141, US

(73) Assignee: PARKER HANNIFIN CORPORATION, Cleveland, OH (US)

(21) Appl. No.: 12/336,948

(22) Filed: Dec. 17, 2008

(51) Int. Cl. F16K 31/02

(52) U.S. Cl. 251/129.01

(57) ABSTRACT

A piezo valve having a rocker valve member and a diaphragm which isolates the fluid ports of the valve from the piezo actuation member. The piezo actuation member is adjustably positioned within the valve to optimize the stroke of the rocker and the preload of the rocker against at least one port of the valve.

### CROSS REFERENCE TO RELATED APPLICATIONS

The present application claims the benefit of the filing date of U.S. Provisional Patent Application Ser. No. 61/014,233, filed Dec. 17, 2007, the disclosure of which is incorporated herein by reference.

### TECHNICAL FIELD

This invention relates to valves, and more particularly to a piezo valve having a rocker valve member and a diaphragm which isolates the fluid ports of the valve from the piezo member.

### BACKGROUND

Rocker valves operated by a solenoid have utilized a diaphragm to isolate the fluid ports from the solenoid actuator. An example is shown in FIG. 1 at 110. These valves are typically of the three-way type, including a fluid inlet port and two outlet ports. The valve member rocks between two extreme positions in which it closes one or the other of the outlet ports, the inlet port being constantly open. The valve member is located within a chamber formed in the valve body, the valve ports opening into the chamber.

The solenoid armature rocks the valve member between its two extreme positions. A flexible diaphragm, within the chamber, surrounds the valve member and extends radially outwardly from it, the radially outward margin of the diaphragm being gripped by the valve body. The diaphragm serves to isolate the valve operator from the valve ports, so that the solenoid is never contacted by the fluid being handled by the valve.

### SUMMARY

At least one embodiment of the invention provides a valve comprising: a valve body having a chamber; a plurality of ports in the valve body communicating with the chamber, at least one of the ports being adapted for connection to a source of fluid under pressure; a rocker valve member within the chamber, the rocker valve member being pivotable to close and open at least one of the ports; a piezo actuator for pivoting the rocker valve member; and a diaphragm within the chamber extending between the rocker valve member and the valve body, the diaphragm isolating the piezo actuator from the pressurized fluid.

At least one embodiment of the invention provides a valve comprising: a valve body including a housing, a base, and a housing cover; a plurality of ports in the base of the valve body, at least one of the ports being adapted for connection to a source of fluid under pressure; a rocker valve member within the housing, the rocker valve member being pivotable to close and open at least one of the ports; a piezo actuator for pivoting the rocker valve member; a diaphragm positioned between the rocker valve member and the base of the valve body and between the rocker valve member and the housing of the valve body, the diaphragm isolating the piezo actuator from the pressurized fluid; a biasing member for biasing a portion of the rocker against the piezo actuator and biasing the piezo actuator against a portion of the cover.

At least one embodiment of the invention provides a valve comprising: a valve body including a housing, a base, and a housing cover; a plurality of ports in the base of the valve body, at least one of the ports being adapted for connection to a source of fluid under pressure; a rocker valve member within the housing, the rocker valve member being pivotable to close and open at least one of the ports; a piezo actuator for pivoting the rocker valve member; a diaphragm positioned between the rocker valve member and the base of the valve body and between the rocker valve member and the housing of the valve body, the diaphragm isolating the piezo actuator from the pressurized fluid; a biasing member for biasing a portion of the rocker against the piezo actuator and biasing the piezo actuator against a portion of the cover; wherein the housing cover is adjustably positioned within the housing and wherein movement of the housing cover adjusts the stroke of the rocker and the preload of the rocker against at least one of the ports.

### BRIEF DESCRIPTION OF THE DRAWINGS

Embodiments of this invention will now be described in further detail with reference to the accompanying drawing, in which:

FIG. 1 is a cross-sectional view of a prior art solenoid actuated rocker valve utilizing a diaphragm isolator;

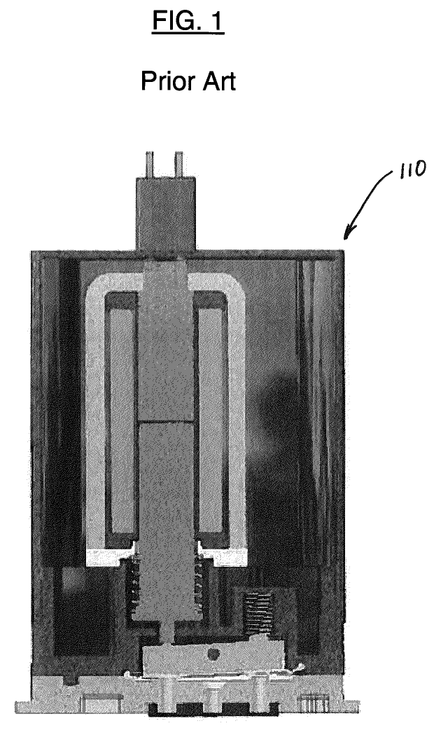

FIG. 2 is a partial cross-sectional view of an embodiment of the piezo actuated valve of the present invention; and

FIG. 3 is a graph of the rocker valve flow test at various pressures and voltages.

### DETAILED DESCRIPTION OF THE DRAWINGS

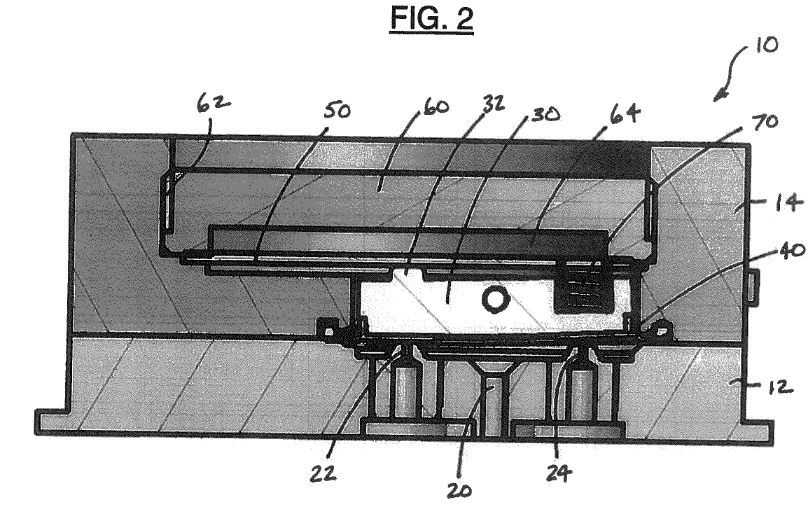

Referring now to FIG. 2 a piezo rocker valve 10 is shown which comprises a valve body having a base 12 and a housing 14. The base 12 includes an inlet port 22, a first outlet port 20 and a second outlet port 24 extending through the base. The inlet port 22 may be connected to a source of pressurized fluid. The housing 14 includes a chamber which houses a rocker 30 which pivotally moves within the chamber to selectively open and close the fluid connection of the inlet port 22 with the first outlet port 20 and the second outlet port 20 in a known fashion. The rocker 30 includes a portion 32 extending from the rocker 30 to engage a piezoelectric actuator member 50. The rocker 30 is biased against the piezoelectric actuator member 50 by a spring 70 as shown. The piezoelectric actuator member 50 is connected to a source of electricity (not shown) which causes movement of the piezoelectric actuator member 50. The movement of the piezoelectric actuator member 50 causes the rocker 30 to move by its engagement with the extending portion 32 of the rocker 30 against the biasing force of the spring 70.

The valve 10 also comprises a diaphragm 40 positioned between the rocker 30/housing 14 and the base 12. The diaphragm 40 prevents fluid from moving past the rocker 40 where it would contact the piezoelectric actuator member 50 or the electrical connection of the piezoelectric actuator member 50 (not shown). Accordingly the diaphragm 40 isolates the fluid from the piezoelectric actuator member 50.

The valve 10 also comprises a cover 60 which is adjustable positioned in the housing 14 by a threaded engagement 62. The cover 60 also engages the piezoelectric actuator member 50 and applies an adjustable preload to the valve through the threaded engagement 62. It is noted that the piezoelectric actuator member 50 is moveably positioned within the housing 14. As previously mentioned, the rocker 30 is biased against the piezoelectric actuator member 50 by a spring 70 as shown, such that the outer portions of the piezoelectric actuator member 50 engage the bottom of the cover 60. The cover 60 can be moved toward the base 12 or away from the base 12 as needed. The rocker 30, pivots with the movement of the cover 60, keeping the piezoelectric actuator member 50 biased against the cover 60. The result is that the distance (stroke) that the rocker 30 moves as it pivots during actuation of the valve 10 is adjustable. It also allows an adjustable preload of the rocker 30 against the inlet port 22 to optimize the force closing the inlet port 22 (i.e. the cover 60 moved toward the base 12 reduces the stroke of the valve and increases the sealing force of the diaphragm covered rocker 30 against the port 22).

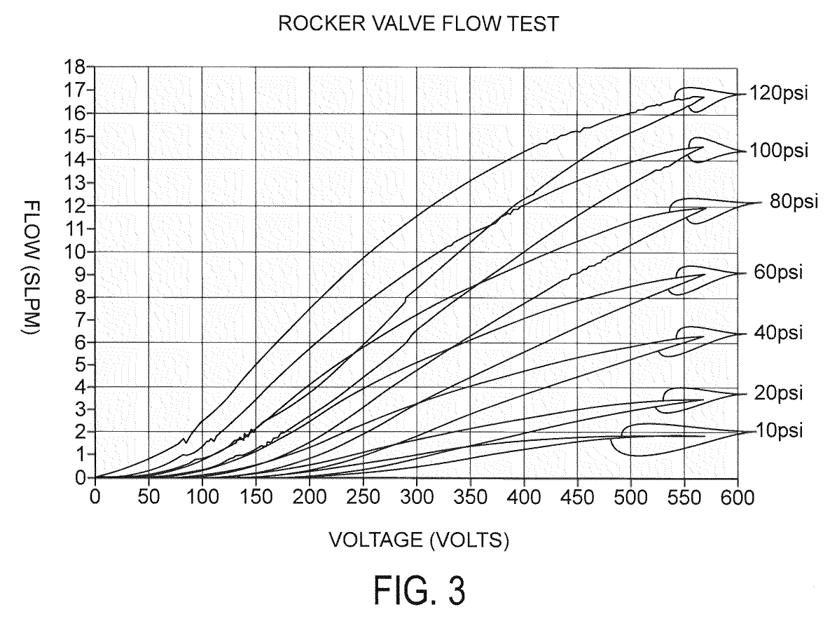

Referring to FIG. 3, a working prototype of an embodiment of the invention was tested at various pressures. The performance data was plotted on the graph showing the flow at different voltages applied to the piezo actuator.

The concept allows the use of piezo actuation technology in commercial applications where the use of high voltage would normally have been a concern because with the present invention the piezoelectric actuator is isolated from the fluid path with an isolation diaphragm and a conventional rocker. The diaphragm also prevents the piezo actuator from contaminating the process media and prevents media ignition or explosion. Another benefit is that the diaphragm reduces the volume of unflushed regions causing media contamination This method eliminates the use of sliding seals of bellows type isolation diaphragms. This concept also uses less parts to minimize the complexity of the valve.

Although the principles, embodiments and operation of the present invention have been described in detail herein, this is not to be construed as being limited to the particular illustrative forms disclosed. They will thus become apparent to those skilled in the art that various modifications of the embodiments herein can be made without departing from the spirit or scope of the invention.

What is claimed is:

1. A valve comprising:
a valve body having a chamber;
a plurality of ports in the valve body communicating with the chamber, at least one of the ports being adapted for connection to a source of fluid under pressure;
a rocker valve member within the chamber, the rocker valve member being pivotable to close and open at least one of the ports;
a piezo actuator for pivoting the rocker valve member; and
a diaphragm within the chamber extending between the rocker valve member and the valve body, the diaphragm isolating the piezo actuator from the pressurized fluid.

2. The valve of claim further comprising a biasing member for biasing a portion of the rocker against the piezo actuator.

3. The valve of claim 2, wherein the valve body includes a valve cover which adjustably positions the piezo actuator within the chamber.

4. The valve of claim 2, wherein the biasing member is a spring.

5. The valve of claim 3, wherein the cover is threadably attached to the valve body.

6. A valve comprising:
a valve body including a housing, a base, and a housing cover;
a plurality of ports in the base of the valve body, at least one of the ports being adapted for connection to a source of fluid under pressure;
a rocker valve member within the housing, the rocker valve member being pivotable to close and open at least one of the ports;
a piezo actuator for pivoting the rocker valve member;
a diaphragm positioned between the rocker valve member and the base of the valve body and between the rocker valve member and the housing of the valve body, the diaphragm isolating the piezo actuator from the pressurized fluid;
a biasing member for biasing a portion of the rocker against the piezo actuator and biasing the piezo actuator against a portion of the cover.

7. The valve of claim 6, wherein the cover of the valve body is adjustably positioned within the housing.

8. The valve of claim 7, wherein the cover is threadably attached to the valve body.

9. A valve comprising:
a valve body including a housing, a base, and a housing cover;
a plurality of ports in the base of the valve body, at least one of the ports being adapted for connection to a source of fluid under pressure;
a rocker valve member within the housing, the rocker valve member being pivotable to close and open at least one of the ports;
a piezo actuator for pivoting the rocker valve member;
a diaphragm positioned between the rocker valve member and the base of the valve body and between the rocker valve member and the housing of the valve body, the diaphragm isolating the piezo actuator from the pressurized fluid;
a biasing member for biasing a portion of the rocker against the piezo actuator and biasing the piezo actuator against a portion of the cover;
wherein the housing cover is adjustably positioned within the housing and wherein movement of the housing cover adjusts the stroke of the rocker and the preload of the rocker against at least one of the ports.

10. The valve of claim 9, wherein the cover is threadably attached to the valve body.
